(19) United States
(12) Patent Application Publication
(10) Pub. No.: US 2015/0202533 A1
(43) Pub. Date: Jul. 23, 2015

(54) MAPPING TOUCHSCREEN GESTURES TO ERGONOMIC CONTROLS ACROSS APPLICATION SCENES

(71) Applicant: NVIDIA CORPORATION, Santa Clara, CA (US)

(72) Inventors: David Lee ENG, San Jose, CA (US); Shichang ZHAO, Shanghai (CN); Yichun SHEN, Shanghai (CN); Jun SU, Shanghai (CN); Liangchuan MI, Union City, CA (US)

(73) Assignee: NVIDIA CORPORATION, Santa Clara, CA (US)

(21) Appl. No.: 14/160,339

(22) Filed: Jan. 21, 2014

(51) Int. Cl. A63F 13/426; A63F 13/2145; G06F 3/0488; G06F 3/038; G06F 3/02; G06F 3/0481

(52) U.S. Cl. CPC A63F 13/426; G06F 3/0227; G06F 3/04817; G06F 3/0488; G06F 3/038; A63F 13/2145

(57) ABSTRACT

A technique of implementing on-screen gestures associated with a software application comprises receiving a first control input that relates to a first scene associated with the software application, translating the first control input into a first set of instructions based on a first mapping, and providing the first set of instructions to an operating system that includes the first set of instructions in the software application, receiving a second control input that relates to a second scene associated with the software application, translating the second control input into a second set of instructions based on a second mapping, and providing the second set of instructions to the operating system, wherein the operating system is configured to include the second set of instructions in the software application.

### FIELD OF THE INVENTION

Embodiments of the present invention relate generally to computing systems and, more specifically, to mapping touchscreen gestures to ergonomic controls across application scenes.

### DESCRIPTION OF THE RELATED ART

With some software applications, a user may navigate and interact with the application by performing certain touch-oriented gestures via a touchscreen input mechanism. Employment of a touchscreen input mechanism is particularly common in video game applications, such as those downloaded for use on tablets or smart phones, since a touchscreen is the primary means of input for such devices. But while such applications are oftentimes designed for user navigation and interaction via a touchscreen input mechanism, other computing devices besides tablets and smart phones may also be used to run these programs.

Video gaming consoles are well-suited for running many video game applications, but considerably less so for touchscreen-oriented programs, such as video games originally designed for tablets. This is because gaming consoles typically include ergonomic mechanical navigation controls that greatly facilitate navigating and interacting with a video game application, but these controls are typically unavailable for use with touchscreen-oriented programs. Thus, a user must resort to using touchscreen-based controls on the integrated screen of the controller, which results in a lower-quality gaming experience. Consequently, for some touchscreen-oriented programs, these mechanical navigation controls, e.g., buttons and joystick controllers, can be mapped to particular locations on the screen of the gaming console and used to mimic an actual user touch on the touchscreen. However, for video games that include multiple scenes, the advantages of using a video gaming console in this particular fashion is limited. Because the mechanical navigation controls can only be mapped to the on-screen touch controls of a single scene of the video game application, the same mapping must be used across all scenes in the video game. Thus, for any other scene in the application that does not have touch controls identical to the touch controls of the mapped scene, navigation and other interactions must rely on the touch controls displayed on the touchscreen of the video gaming console.

As the foregoing illustrates, what is needed in the art is a more effective way to execute software applications that are designed for touchscreen interactions on computing devices with mechanical controls.

### SUMMARY OF THE INVENTION

One embodiment of the present invention sets forth a method for implementing on-screen gestures associated with a software application. The method includes receiving a first control input that relates to a first scene associated with the software application, translating the first control input into a first set of instructions recognizable to the software application based on a first mapping of the first control input to at least one touch location within a region of the first scene, and providing the first set of instructions to an operating system that is configured to include the first set of instructions in the software application. The method also includes receiving a second control input that relates to a second scene associated with the software application, translating the second control input into a second set of instructions recognizable to the software application based on a second mapping of the second control input to at least one touch location within a region of the second scene, wherein the second mapping is different than the first mapping, and providing the second set of instructions to the operating system, wherein the operating system is configured to include the second set of instruction in the software application.

One advantage of the disclosed embodiments is that mechanical control inputs can be implemented as on-screen gestures in a software application that is normally controlled by touchscreen gestures. Such mechanical control inputs can be used to navigate and interact with a software application even when the application includes multiple scenes with different touchscreen controls. An additional advantage is that a user or third party can create a custom mapping for a particular application and make this mapping available to other users via cloud computing.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention.

FIG. 2 is a perspective view of a video gaming console that is a specific implementation of the computer system of FIG. 1, according to one embodiment of the present invention.

FIG. 3 is a block diagram illustrating a system architecture implemented in the video gaming console of FIG. 2, according to an embodiment of the present invention.

FIG. 4 schematically illustrates four scenes of a software application that may be executed by the video gaming console of FIG. 2, according to one embodiment of the present invention.

FIG. 5 conceptually illustrates an application-specific mapping for a particular software application, according to an embodiment of the present invention.

FIG. 6 sets forth a flowchart of method steps for implementing on-screen gestures associated with a software application, according to one embodiment of the present invention.

FIG. 7 sets forth a flowchart of method steps for translating control input signals into instructions recognizable to a software application that is designed for touchscreen interactions.

For clarity, identical reference numbers have been used, where applicable, to designate identical elements that are common between figures. It is contemplated that features of one embodiment may be incorporated in other embodiments without further recitation.

### DETAILED DESCRIPTION

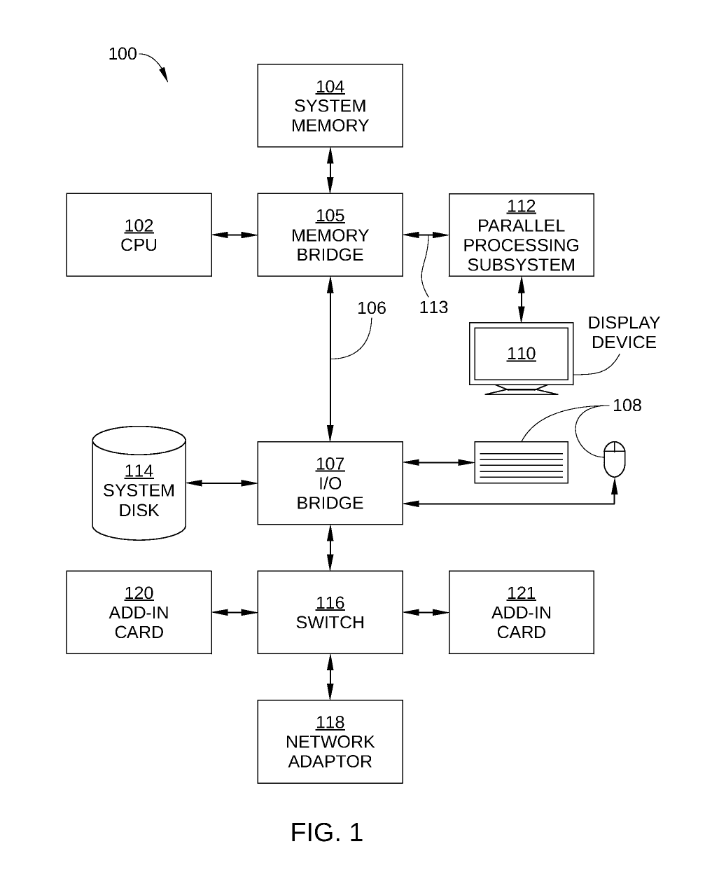

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard, a mouse, or game console control buttons, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. Such circuitry may be incorporated across one or more parallel processing units (PPUs) included within parallel processing subsystem 112, and one or more of these PPUs may be configured as a graphics processing unit (GPU). Alternatively, such circuitry may reside in a device or sub-system that is separate from parallel processing subsystem 112, such as memory bridge 105, I/O bridge 107, or add-in cards 120 or 121.

In other embodiments, the parallel processing subsystem 112 incorporates circuitry optimized for general purpose and/or compute processing. Again, such circuitry may be incorporated across one or more PPUs that are included within parallel processing subsystem 112 and configured to perform such general purpose and/or compute operations. In yet other embodiments, the one or more PPUs included within parallel processing subsystem 112 may be configured to perform graphics processing, general purpose processing, and compute processing operations.

System memory 104 includes at least one device driver 103 configured to manage the processing operations of the one or more PPUs within parallel processing subsystem 112. In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 is connected to CPU 102 directly rather than through memory bridge 105, and other devices communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 may be eliminated, and network adapter 118 and add-in cards 120 and 121 connect directly to I/O bridge 107.

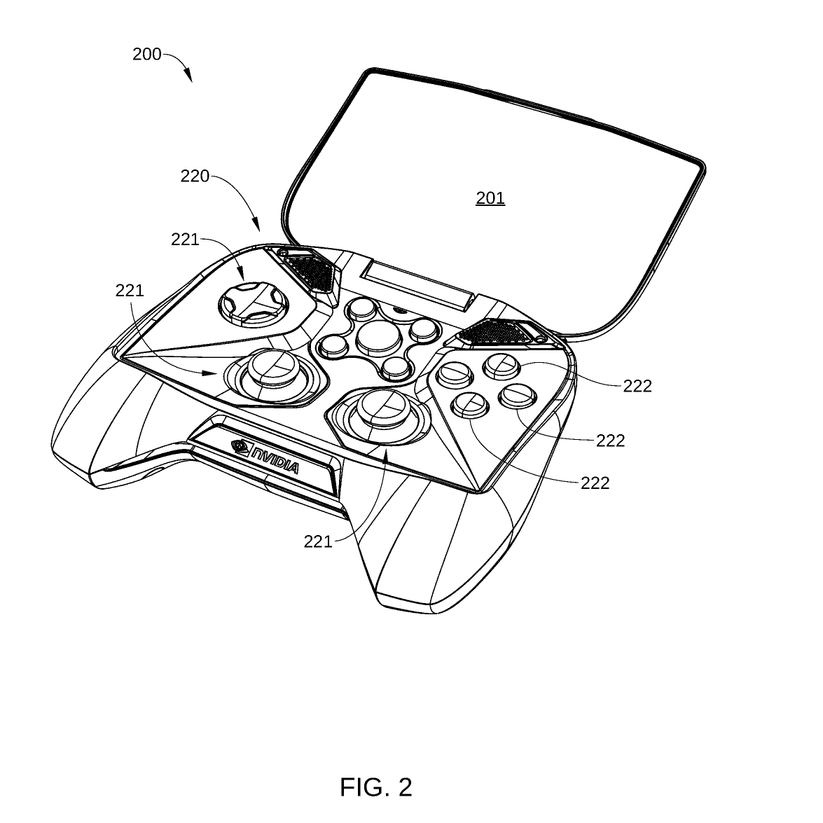

FIG. 2 is a perspective view of a video gaming console that is a specific implementation of the computer system of FIG. 1, according to one embodiment of the present invention. As shown, video gaming console 200 may be one embodiment of computer system 100 in FIG. 1, and may include some or all of the elements thereof described in conjunction with FIG. 1. Video gaming console 200 is any technically feasible video gaming console configured to run a software application in which user navigation and/or interaction can be performed using touchscreen controls. As described herein, video gaming console 200 is configured for running such a software application even when the software application includes multiple scenes that each have different touchscreen controls. Video gaming console 200 generally includes an integrated screen 201 and mechanical input controls 220.

Integrated screen 201 is a display device, such as display device 110 in FIG. 1, that provides visual output to a user from a video game application being run with video gaming console 200. In addition, integrated screen 201 is generally an integrated component of video gaming console 200. In some embodiments, integrated screen 201 may be configured as a touch-sensitive screen, or “touchscreen,” that allows user inputs to be provided via touch gestures to a video game application being run on video gaming console 200.

Mechanical input controls 220 greatly facilitate navigation and interaction with a video game application being run with video gaming console 200. This is because mechanical input controls 220 are significantly more ergonomic and responsive than touchscreen controls typically used on electronic tablets and smart phones. As shown, mechanical input controls 220 may include one or more joystick controllers 221 and a plurality of control buttons 222. Joystick controllers 221 and control buttons 222 may be arranged in any other configuration than that illustrated in FIG. 2 without exceeding the scope of the invention. For example, joystick controllers 221 and control buttons 222 may be disposed on any of the surfaces of console body 230 to facilitate navigation of a software application by a user rather than only on the surfaces illustrated in FIG. 2.

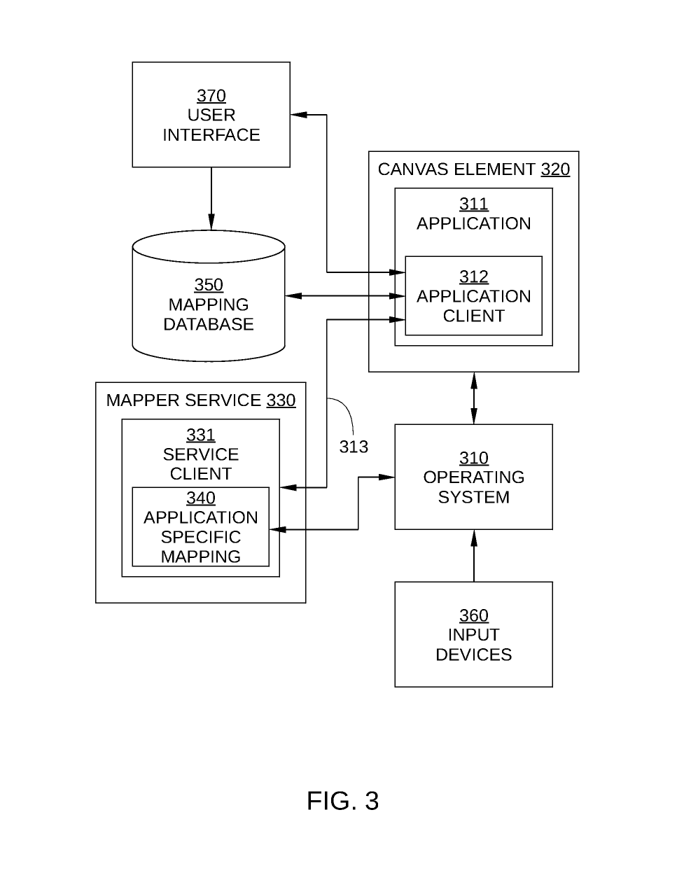

FIG. 3 is a block diagram illustrating a system architecture 300 implemented in video gaming console 200 in FIG. 2, according to an embodiment of the present invention. System architecture 300 enables mechanical control inputs from a computing device to be implemented as on-screen gestures in a software application that is controlled by touchscreen gestures, even when the software application includes multiple scenes that each have different touchscreen controls. For clarity, system architecture 300 is described herein with respect to video gaming console 200, although it is understood that system architecture 300 may be implemented with any suitable computing device. As shown, system architecture 300 includes an operating system (OS) 310 associated with video gaming console 200, a canvas element 320, a mapper service 330, and a mapping database 350. In some embodiments, system architecture 300 also includes a user interface 370 that enables a user to perform operations outside of a software application currently running on video gaming console 200.

OS 310 resides in physical memory of video gaming console 200 during operation, such as in system memory 104 in FIG. 1. OS 310 is generally a collection of software that manages hardware resources of video gaming console 200 and provides common services for software applications being run on video gaming console 200. OS 310 may also be responsible for communicating input signals to software applications being run on video gaming console 200. For example, such input signals may be received from input devices 360 associated with video gaming console 200, such as joystick controllers 221 and control buttons 222. In operation, OS 310 generates canvas element 320 and mapper service 330 and, in some embodiments, launches user interface 370. OS 310 generates mapper service 330 whenever video gaming console 200 is in operation. In contrast, OS 310 is configured to generate canvas element 320 and/or user interface 370 when a software application is being run on video gaming console 200, such as application 311.

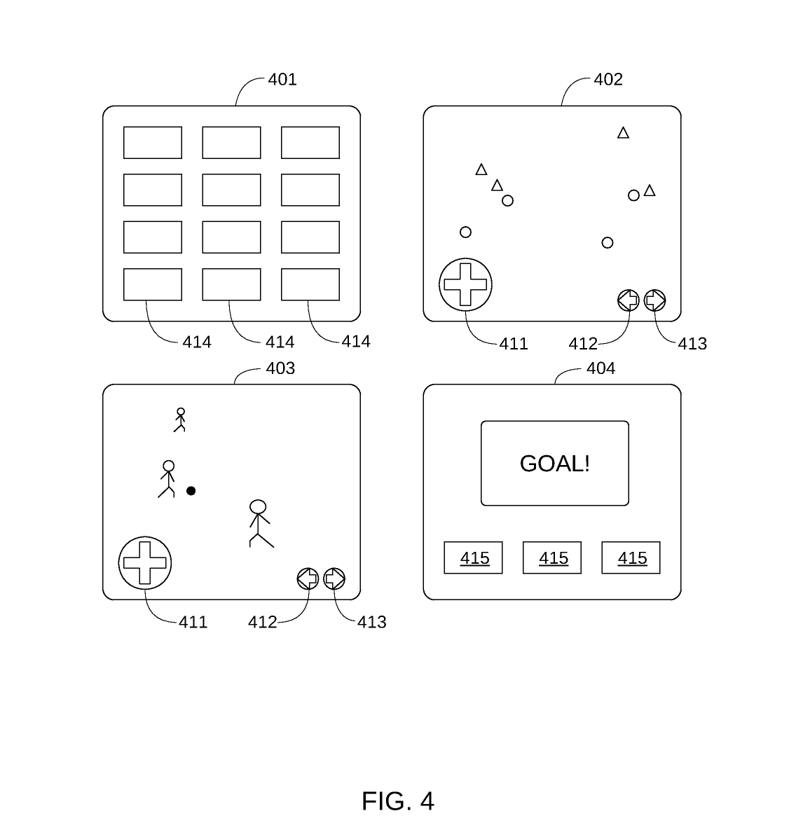

Application 311 is any suitable software application configured to run on video gaming console 200. For example, in some embodiments, application 311 is a video game application. Alternatively, application 311 may be a drafting program or any other software application that may benefit by being navigated or interacted with by a user via mechanical input controls 220 of video gaming console 200 instead of via touchscreen controls displayed on integrated screen 201. In some embodiments, upon startup, application 311 generates an application client 312, which establishes a connection 313 to mapper service 330. As described below, application client 312 can send to mapper service 330 an application-specific mapping 340 associated with application 311. Application 311 may be a particular video game application or other application that is configured to cause touchscreen-based controls (such as an icon) to be displayed on integrated screen 201 for user navigation and interaction with application 311. In addition, application 311 typically includes multiple scenes (also referred to as pages), where each scene has a different configuration of touchscreen-based controls. Ordinarily, a user navigates between these multiple scenes using the touchscreen-based controls displayed on integrated screen 201, as illustrated in FIG. 4.

FIG. 4 schematically illustrates four scenes 401-404 of application 311, according to one embodiment of the present invention. For example, when application 311 is a soccer-themed video game application, scene 401 may be a menu screen, scene 402 may be a plan view of a soccer field or portion of a soccer field in which players are shown as icons and a user avatar navigates, scene 403 may be a perspective view representation of the soccer field from the point of view of the user avatar, and scene 404 may be pop-up window that is superimposed on a previously active screen, for example when a goal is scored. As shown, some of scenes 401-404 have identical or similar touchscreen-based controls and other scenes have completely different touchscreen-based controls. For instance, scenes 402 and 403 each include a joystick control icon 411, a “Go To Previous Scene” icon 412, and a “Go To Next Scene” icon 413, where a user touch to each of these icons causes an appropriate input to application 311. In contrast, scene 401 includes a plurality of menu option button icons 414, and scene 404 includes several scene-specific button icons 415, such as “Resume Gameplay,” “Review Previous Play,” and “Go To Menu,” etc.

Referring back now to FIG. 3, canvas element 320 is configured to allow dynamic, scriptable rendering of 2D shapes and bitmap images for display on integrated screen 201, such as images and shapes generated by a software application being run on video gaming console 200. Canvas element generally includes a drawable region defined with height and width attributes, and enables application 311 to render images to all or part of integrated screen 201, such as one or more of scenes 401-404 in FIG. 4.

Mapper service 330 is configured to run as a background process, and is generated by OS 310 during operation of video gaming console 200. When application 311 is started and connection 313 is established between application client 312 and mapper service 330, mapper service 330 creates service client 331, which is configured to communicate with application 311. For example, in some embodiments, service client 331 is configured to receive an application-specific mapping 340 from application client 312, which is associated with application 311. In addition, in various embodiments, service client 331 is configured to recognize control inputs (for example when mechanical input controls 220 are manipulated by a user), translate these control inputs into instructions recognizable to application 311, and send the instructions to OS 310 to be included in or performed by application 311. Service client 331 bases the translation of the control inputs into instructions on a mapping of one or more mechanical control inputs to one or more respective touch locations within a region of the currently active scene of application 311, where an input indicates a user touch occurring at the corresponding touch location the current scene. Such mappings may be included in application-specific mapping 340, and are described in greater detail below.

Application-specific database 340 includes multiple mappings of mechanical control inputs to screen touches or gestures for a particular application 311. The mechanical control inputs that are mapped are from, for example, mechanical input controls 220, and the screen entries or gestures are the screen-based inputs for user navigation and interaction normally used in application 311, such as when a user touches integrated screen 201.

Because application 311 typically includes multiple scenes or pages, the application-specific database 340 for application 311 includes a separate mapping of mechanical control inputs for some or each different scene of application 311. In this way, an input from a particular input device 360 (e.g., a specified motion of joystick controller 221 or depression of a particular control button 222) can be used for user navigation of multiple scenes of application 311. For example, referring back again to FIG. 4, in scenes 402 and 403, the four different motions (up, down, left, and right) of joystick controller 221 of video gaming console 200 can mapped to the corresponding motions of joystick control icon 411. In contrast, in scene 401, which is a menu scene, the four different motions of the joystick controller may each be mapped to a different menu selection. Consequently, rather than relying on screen touches to navigate and/or interact with application 311, a user can instead employ the mechanical input controls 220 of video gaming console 200, even when application 311 includes multiple scenes that each have different touchscreen controls.

In some embodiments, an application-specific mapping 340 for a particular application 311 includes a separate mapping of mechanical control inputs to screen entries or gestures for every page or scene in application 311. In other embodiments, application-specific mapping 340 includes a different mapping for multiple pages or scenes in application 311, but not necessarily for each page or scene in application 311.

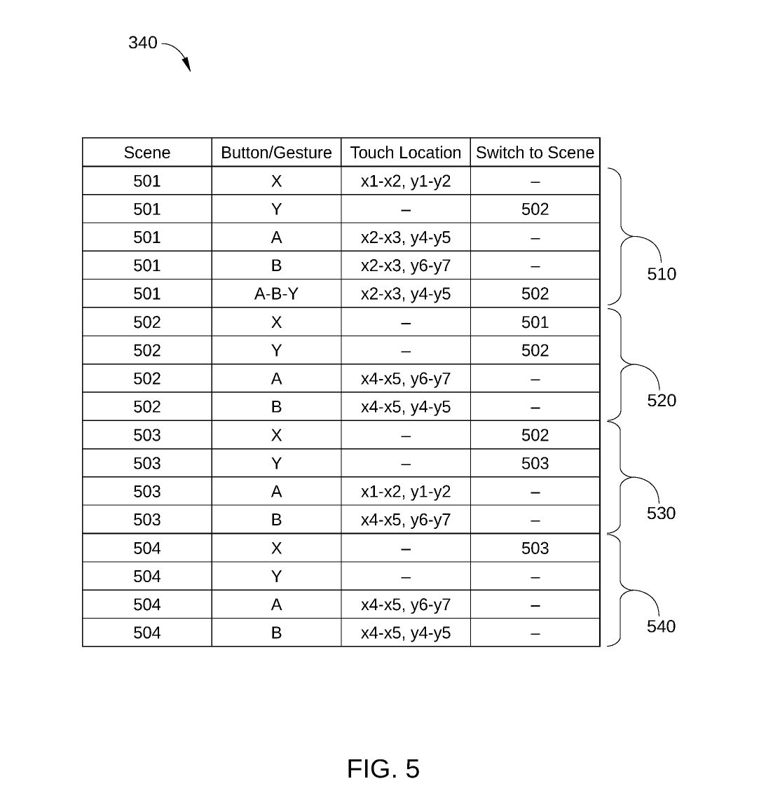

FIG. 5 conceptually illustrates an application-specific mapping 340 for a particular software application 311, according to an embodiment of the present invention. As shown, each scene of application 311, which in this example includes scenes 501-504, has a respective mapping 510, 520, 530, 540 of control buttons X, Y, A, and B, where buttons X, Y, A, and B are selected from control buttons 222 of video gaming console 200. For each scene of application 311, each of control buttons X, Y, A, and B or a control gesture (i.e., a unique combination of these control buttons) is mapped to a different corresponding touch location. The corresponding touch location for a particular control button or control gesture is the location on integrated screen 201 that service client 331 indicates to application 311 on which a user touch has occurred. For example, according to mapping 510, when scene 501 is the active scene of application 311 and a user presses button A, a user touch is reported to application 311 in the region defined by X2 to X3 and Y4 to Y5. It is noted that when scene 501 is not the active scene of application 311, mapping 510 is not used for buttons X, Y, A, and B.

In some embodiments, one or more control buttons or control gestures cause the currently active scene of application 311 to switch to a different scene of application 311. For example, according to mapping 510, when scene 501 is the active scene of application 311 and a user depresses button Y, the active scene of application 311 changes from scene 501 to scene 502. In some embodiments, such a scene change may also occur in conjunction with a screen touch. For example, according to mapping 510, when scene 501 is the active scene of application 311 and a user simultaneously presses buttons A, B, and Y, the active scene of application 311 changes from scene 501 to scene 502 and a user touch is reported to application 311 in the region defined by X2 to X3 and Y4 to Y5.

In the embodiment illustrated in FIG. 5, when a user repeatedly depresses the Y button, scenes 501-504 are cycled through as the active scene of application 311 in ascending order. Similarly, as a user repeatedly depresses the X button, scenes 501-504 are cycled through as the active scene of application 311 in descending order. It is noted that as each scene is selected as the active scene of application 311, a different mapping included in application-specific mapping 340 is used by service client 331 to translate mechanical control inputs from mechanical input controls 220 into on-screen touches by a user.

Any other control button mapping may be used to indicate scene changes and other user touches. For example, in some embodiments, some or all scenes of application-specific mapping 340 each have a particular control button or control gesture associated therewith that is the same in each scene. Thus, no matter what scene in active in application 311, when a user depresses the particular control button or performs the control gesture associated with a particular scene, that particular scene becomes the active scene of application 311. In this way, a user may manually select a specific scene of application 311 regardless of what scene is currently the active scene of application 311. In such an embodiment, each mapping in application-specific mapping 340 includes a number of identical control button/control gesture entries, one for each scene mapped in this way. Furthermore, in such an embodiment, it is noted that service client 331 may also be notified what scene is currently active when a particular control button or control gesture is actuated by a user to manually change scenes. Such notification enables service client 331 to use the appropriate mapping (e.g., mapping 510, 520, 530, or 540).

As described above, in some embodiments the active scene of application 311 is directly, or “manually,” selected by performing a control gesture or by depressing a control button that is mapped to switch to a particular scene. In other embodiments, the active scene of application 311 is changed using a control button or control gesture that is mapped to a touch location of the active scene of application 311 that corresponds to a change scene command or icon within the active scene. Thus, in such embodiments, the internal controls of application 311 may be used to perform the scene change. However, because a control button is depressed or a control gesture is performed to initiate such a scene change, service client 331 can still accurately track what scene is the active scene of application 311 and use the appropriate mapping when mechanical input controls 220 of video gaming console 200 are subsequently used.

In some embodiments, service client 331 can automatically determine what scene of application 311 is currently active. Specifically, in some embodiments, service client 331 determines the currently active scene of application 311 based on image data, such as data residing in a frame buffer of video gaming console 200. By examining the contents of such a frame buffer, service client 331 can detect previously established markers included in each scene to determine which scene is currently active, i.e., being displayed on integrated screen 201. Alternatively or additionally, service client 331 may use real-time image processing of data residing in a frame buffer to recognize what scene is currently active in application 311. For example, specific touchscreen control icons or other shapes in the currently active scene may be used by service client 331 to automatically determine which scene this is. Service client 331 then uses the appropriate mapping associated with the active scene when mechanical input controls 220 of video gaming console 200 are used. In some embodiments, service client 331 automatically determines the active scene of application 311 whenever mechanical control inputs from mechanical input controls 220 are received.

In some embodiments, service client 331 uses any combination of the above-described approaches for determining what scene of application 311 is currently active. For instance, the manual selection of an active scene may be used in combination with the fully automatic determination approach involving real-time image processing of data residing in a frame buffer of video gaming console 200. In one example embodiment, the manual selection approach may be used to override automatic scene determination by service client 331. In another embodiment, the manual selection approach is used in lieu of real-time image processing when conserving energy and/or computing resources is especially beneficial.

In some embodiments, one or more of application-specific databases 340 reside locally in video gaming console 200. For example, in some instances mappings for mechanical input controls 220 is provided with a particular application 311. Alternatively, whenever a particular application 311 is first launched in video gaming console 200, application client 312 determines whether a suitable application-specific mapping 340 is present in video gaming console 200. If not, such as when mappings for mechanical input controls 220 are not provided with an application 311, application client 312 can access an appropriate application-specific mapping 340 from a local or remote database, such as mapping database 350. In some embodiments, application client 312 can access an appropriate application-specific mapping 340 via the Internet or other communication network.

In some embodiments, application client 312 is configured to store user-selected mappings for a particular application 311 in mapping database 350. In such embodiments, application client 312 records the user-selected mappings when a user utilizes user interface 370, which may be a drop-down menu that operates outside of application 311. Application client 312 then stores the mappings for application 311 in a dedicated mapping database 350, which may reside locally in video gaming console 200 and/or remotely, such as in a server accessible by other users of application 311. For reference, the application-specific mapping 340 may be stored with an appropriate package (pkg) name indicating the intended application 311.

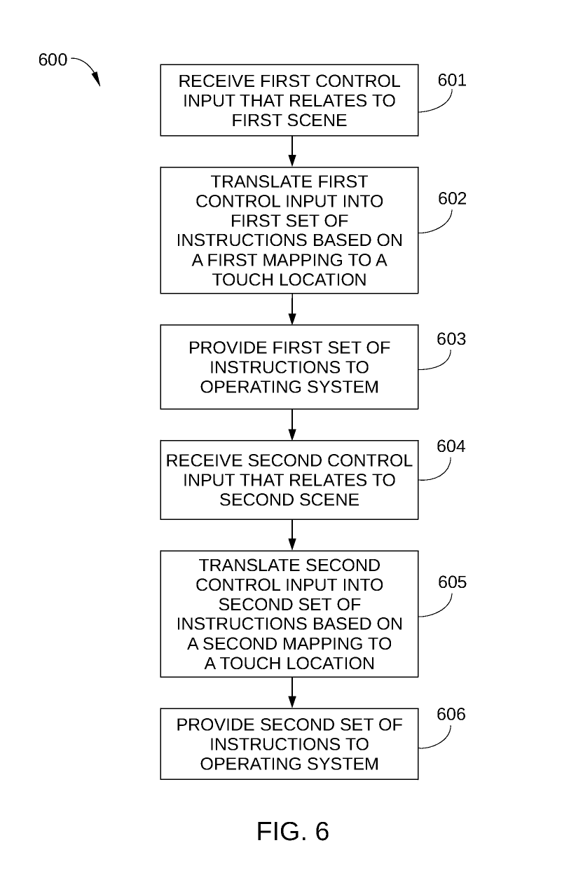

FIG. 6 sets forth a flowchart of method steps for implementing on-screen gestures associated with a software application, according to one embodiment of the present invention. Although the method steps are described with respect to the systems of FIGS. 1-5, persons skilled in the art will understand that any system configured to perform the method steps, in any order, falls within the scope of the present invention.

Prior to implementation of the method steps, an application-specific mapping 340 is generated for one or more mechanical input controls 220 of video gaming console 200, where application-specific mapping 340 includes a mapping for two or more scenes of a particular application 311. The mapping for each scene associates at least one touch location within a region of the scene with a particular control input from mechanical input controls 220, where the control input is generated when a user actuates one of (or a combination of) mechanical input controls 220. Application-specific mapping 340 may be generated by a developer of application 311, a user of application 311, and/or a manufacturer of video gaming console 200, and may be stored locally in video gaming console 200 and/or in remote mapping database 350. Mapping database 350 may be available via a communication network, such as the Internet.

In some embodiments, the mappings for the two or more scenes of application 311 are accessed from a database associated with application 311, such as mapping database 350, prior to the method. For example, when application 311 is initially launched, application client 312 (or any other suitable control circuit or system) may search for a locally available application-specific mapping 340 for application 311. Typically, application client 312 is created when application 311 is first launched. If such a mapping is not stored locally in video gaming console 200, application client 312 is configured to search for application-specific mapping 340 in a remote mapping database 350.

As shown in FIG. 6, a method 600 begins at step 601, where service client 331 receives a first control input that relates to a first scene associated with application 311. Generally, the first scene is the active scene of application 311, since control inputs typically cannot be received from inactive scenes of application 311. In addition, the control input is generated by one or more mechanical input devices, such as a particular control button 222, joystick controller 221, a key of a keyboard, and/or a selector button of a computer mouse.

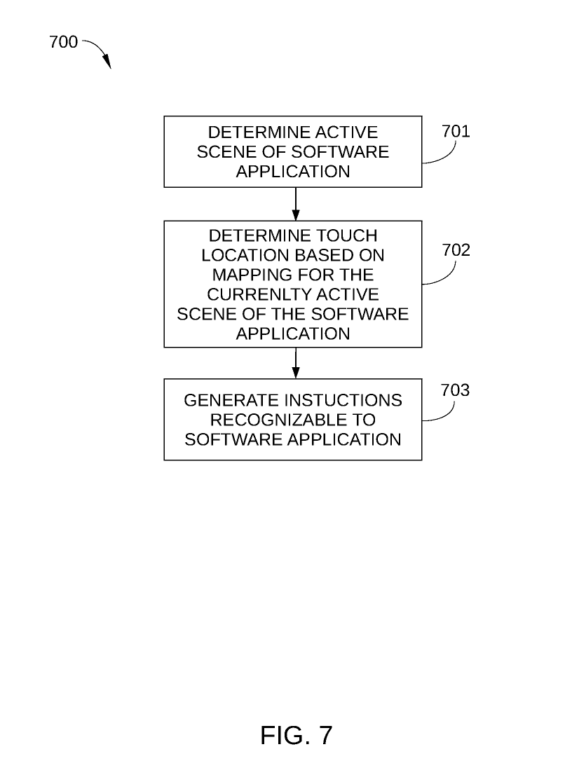

In step 602, service client 331 translates the first control input into a first set of instructions recognizable to application 311 based on a first mapping of the first control input to at least one touch location within a region of the first scene. For example, a touch location to which the first control input is mapped corresponds to a touchscreen-based control icon displayed on integrated screen 201 for user navigation and interaction with application 311. An example embodiment of step 602 is described in greater detail below in conjunction with FIG. 7.

In step 603, service client 331 provides the first set of instructions to OS 310, where OS 310 is configured to include the first set of instructions in the software application. In this way, physical actuation of mechanical input devices by a user can be realized as on-screen touches in a software application that is configured for user interaction via a touchscreen.

In step 604, service client 331 receives a second control input that relates to a second scene associated with application 311, where the second control input is generated by one or more mechanical input devices.

In step 605, service client 331 translates the second control input into a second set of instructions recognizable to application 311 based on a second mapping of the second control input to at least one touch location within a region of the second scene, wherein the second mapping is different than the first mapping. It is noted that the first mapping and the second mapping are generally included in application-specific mapping 340. An example embodiment of step 605 is described in greater detail below in conjunction with FIG. 7.

In step 606, service client 331 provides the second set of instructions to OS 310, wherein OS 310 is configured to include the second set of instructions in application 311. Thus, physical actuation of mechanical input devices by a user can be realized as on-screen touches in multiple scenes of application 311, even though each of the multiple scenes of application 311 has a different mapping of mechanical input devices to on-screen touches.

FIG. 7 sets forth a flowchart of method steps for translating control input signals into instructions recognizable to a software application that is designed for touchscreen interactions. In some embodiments, a method 700 of FIG. 7 may be performed as step 602 and/or step 605 of method 600 illustrated in FIG. 6. Although the method steps are described with respect to the systems of FIGS. 1-5, persons skilled in the art will understand that any system configured to perform the method steps, in any order, falls within the scope of the present invention.

Prior to implementation of the method steps, and as described above in method 600, service client 331 receives a control input that relates to the currently active scene in application 311. Service client 331 is created by mapper service 330 after application 311 is started and a connection between mapper service 330 and application 311 is established. The received control input is generated by mechanical input controls 220 of video gaming console 200 when actuated by a user.

As shown in FIG. 7, method 700 begins at step 701, where service client 331 determines what scene of application 311 is the active scene, i.e., the scene that is currently displayed and from which user input may be received. In some embodiments, service client 331 determines the active scene of application 311 by tracking what scene has been selected manually by a user. Specifically, service client 331 tracks when one or more control buttons or control gestures actuated by a user cause the currently active scene of application 311 to switch to a different scene of application 311. In some embodiments, service client 331 determines the active scene of application 311 by tracking what scene has been selected via a touchscreen-based control (such as an icon) configured to cause a scene change in application 311. Service client 331 can track the currently active scene in this way if the user touches the touch location corresponding to the scene-change icon or if the user actuates one or more control buttons that are mapped to the touch location of the touchscreen-based control. In some embodiments, service client 331 automatically determines the active scene of application 311 based on image data in the scene that is currently active in application 311.

In step 702, service client 331 determines a touch location from application-specific mapping 340. Because service client 331 tracks which scene of application 311 is active, service client 311 can determine a touch location from application-specific mapping 340 that corresponds to the received control input. It is noted that the touch location determined in step 702 may differ depending on which scene of application 311 is currently active, as illustrated by mappings 510, 520, 530, and 540 in FIG. 5, since the touch location is determined using the particular mapping in application-specific mapping 340 that corresponds to the active scene of application 311.

In step 703, service client 331 generates a set of instructions that are recognizable to application 311 and indicate to application 311 that a touch has occurred in the touch location determined in step 702. In this way, a control input can be translated into a set of instructions recognizable to application 311 indicating a user touch at a touch location within a region of the active scene of application 311.

In sum, the disclosed techniques provide a way to effectively execute software applications that are designed for touchscreen interactions on computing devices with mechanical controls. According to some embodiments, a separate mapping of mechanical control inputs to on-screen gestures is generated and stored for each of multiple scenes in a software application. Thus, for each of the multiple scenes, a different mapping of mechanical control inputs can be employed. Advantageously, multiple scenes of the software application can be navigated using a computing device with mechanical controls, even though the software application is configured for user interaction via a touchscreen.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow.

The claimed invention is:

1. A method of implementing on-screen gestures associated with a software application, the method comprising:
receiving a first control input that relates to a first scene associated with the software application;
translating the first control input into a first set of instructions recognizable to the software application based on a first mapping of the first control input to at least one touch location within a region of the first scene;
providing the first set of instructions to an operating system that is configured to include the first set of instructions within the software application;
receiving a second control input that relates to a second scene associated with the software application;
translating the second control input into a second set of instructions recognizable to the software application based on a second mapping of the second control input to at least one touch location within a region of the second scene, wherein the second mapping is different than the first mapping; and
providing the second set of instructions to the operating system, wherein the operating system is configured to include the second set of instructions within the software application.

2. The method of claim 1, further comprising determining that the first scene of the computer application is currently active based on image data associated with the first scene.

3. The method of claim 2, wherein determining that the first scene of the computer application is currently active is performed prior to translating the first control input for the first scene.

4. The method of claim 1, further comprising accessing the first mapping and the second mapping from a database associated with the software application.

5. The method of claim 1, wherein the first set of instructions comprises one or more instructions that are configured to designate a scene other than the first scene an active scene of the software application.

6. The method of claim 5, further comprising determining that the first scene of the software application is currently active based on the first control input.

7. The method of claim 1, wherein the first control input is generated by at least one mechanical input device.

8. The method of claim 7, wherein the at least one mechanical input device comprises at least one of a control button of a video gaming console, a joystick control of a video gaming console, a key of a keyboard, and a selector button of a computer mouse.

9. The method of claim 1, wherein a touchscreen-based control icon configured for user interaction with the software application resides at the at least one touch location.

10. A non-transitory computer readable medium storing instructions that, when executed by a processor, cause the processor to perform the steps of:
receiving a first control input that relates to a first scene associated with the software application;
translating the first control input into a first set of instructions recognizable to the software application based on a first mapping of the first control input to at least one touch location within a region of the first scene;
providing the first set of instructions to an operating system that is configured to include the first set of instructions in the software application;
receiving a second control input that relates to a second scene associated with the software application;
translating the second control input into a second set of instructions recognizable to the software application based on a second mapping of the second control input to at least one touch location within a region of the second scene, wherein the second mapping is different than the first mapping; and
providing the second set of instructions to the operating system, wherein the operating system is configured to include the second set of instructions in the software application.

11. The non-transitory computer readable medium of claim 10, further comprising instructions that, when executed by the processor, cause the processor to perform the step of determining that the first scene of the software application is currently active based on image data associated with the first scene.

12. The non-transitory computer readable medium of claim 11, further comprising instructions that, when executed by the processor, cause the processor to perform the step of determining the first scene of the software application to be currently active prior to translating the first control input for the first scene.

13. The subsystem of claim 10, further comprising instructions that, when executed by the processor, cause the processor to perform the step of accessing the first mapping and the second mapping from a database associated with the software application.

14. The non-transitory computer readable medium of claim 10, wherein the first set of instructions comprise instructions that make a different scene than the first scene an active scene of the software application.

15. The non-transitory computer readable medium of claim 14, further comprising instructions that, when executed by the processor, cause the processor to perform the step of determining that the first scene of the software application is currently active based on the first control input.

16. The non-transitory computer readable medium of claim 10, wherein the first control input is generated by at least one mechanical input device.

17. The non-transitory computer readable medium of claim 15, wherein the at least one mechanical input device includes at least one of a control button of a video gaming console, a joystick control of a video gaming console, a key of a keyboard, and a selector button of a computer mouse.

18. The non-transitory computer readable medium of claim 10, wherein a touchscreen-based control icon configured for user interaction with the software application resides at the at least one touch location.

19. A computing device comprising:
a processing unit; and
a memory coupled to the processing unit that includes instructions that, when executed by the processing unit, cause the processing unit to:
receive a first control input that relates to a first scene associated with the software application;
translate the first control input into a first set of instructions recognizable to the software application based on a first mapping of the first control input to at least one touch location within a region of the first scene;
provide the first set of instructions to an operating system that is configured to include the first set of instructions in the software application;
receive a second control input that relates to a second scene associated with the software application;
translate the second control input into a second set of instructions recognizable to the software application based on a second mapping of the second control input to at least one touch location within a region of the second scene, wherein the second mapping is different than the first mapping; and
provide the second set of instructions to the operating system, wherein the operating system is configured to include the second set of instructions in the software application.

20. The computing device of claim 19, further comprising a display screen that is coupled to the processing unit and is incorporated in an apparatus that includes the processing unit.
